(19) United States
(12) Patent Application Publication
(10) Pub. No.: US 2008/0145636 A1
(43) Pub. Date: Jun. 19, 2008

(54) Yoga pad and the method of making the same

(75) Inventor: Semi Ko, Hua-Tan Hsiang (TW)

Correspondence Address: BRUCE H. TROXELL, SUITE 1404, 5205 LEESBURG PIKE, FALLS CHURCH, VA, 22041, US

(73) Assignee: SHIUN JIUG INDUSTRIAL CO., LTD.

(21) Appl. No.: 11/640,260

(22) Filed: Dec. 18, 2006

(51) Int. Cl. D04H 1/00; B29C 44/04

(52) U.S. Cl. 428/292.1; 264/45.3

(57) ABSTRACT

A Yuga pad of the present invention includes a flexible foaming member with a plurality of reinforced fibers therein. The Yuga pad is made from a raw material mixed with the reinforced fibers and processed by extrusion and vulcanization. In the extrusion step, an extruder will force the reinforced fiber oriented substantially along an axial direction of the extruder. As a result, after vulcanization step the reinforced fibers in the flexible foaming member still are oriented substantially along a direction.

### BACKGROUND OF THE INVENTION

1. Field of the Invention

The present invention relates generally to a pad, and more particularly to a Yoga pad and the method of making the same.

2. Description of the Related Art

Conventional Yoga pads include a foaming pad member. The foaming pad member has skidproof capacity for user taking Yoga on it. The foaming pad member has a well flexibility also that the foaming pad member always is extended or contracted when user takes Yoga on it. The flexibility of the foaming pad member sometime makes user slip or hurt. An improved Yoga pad is provided with a fabric on the foaming pad member to avoid aforesaid problem. But the fabric is slippery.

In addition, a conventional method of making aforesaid Yoga pad with fabric includes coating adhesive on an unfoamed pad member to attach the fabric on it, and then the unfoamed pad member and the fabric are sent for foaming process. The adhesive will make air or water pollution.

### SUMMARY OF THE INVENTION

The primary objective of the present invention is to provide a Yoga pad and the method of making the same, which the pad member includes reinforced fibers oriented substantially along a direction to replace the fabric and there is no adhesive in the Yoga pad of the present invention.

According to the objectives of the present invention, a Yuga pad of the present invention includes a flexible foaming member with a plurality of reinforced fibers therein, wherein the reinforced fibers are oriented substantially along a predetermined direction.

A method of making the Yuga pad of the present invention includes the steps of preparation a raw material, adding the reinforced fibers into the raw material, extrusion of the raw material with the reinforced fibers and vulcanization. In the extrusion step, the raw material mixed with the reinforced fibers is put into an extruder, and the extruder will force the reinforced fiber oriented substantially along an axial direction of the extruder. As a result, after vulcanization step the reinforced fibers in the flexible foaming member still are oriented substantially along a direction.

### BRIEF DESCRIPTION OF THE DRAWINGS

FIG. 1 is a perspective view of a preferred embodiment of the present invention; and

FIG. 2 is a flow chart of the method of making the present invention.

### DETAILED DESCRIPTION OF THE INVENTION

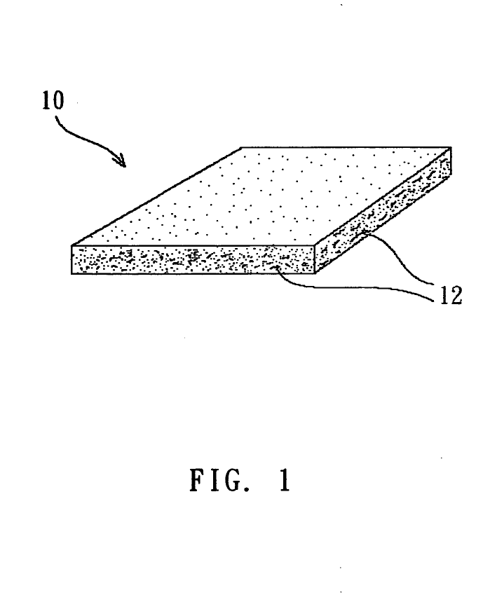

As shown in FIG. 1, a Yoga pad 10 of the preferred embodiment of the present invention includes a foaming member 12. The foaming member 12 is made of a foamed flexible material. The foaming member 12 includes a plurality of reinforced fibers 14 therein, which are made of fibers without flexibility, such as wood fiber or nylon fibers. The reinforced fibers 14 are oriented along a predetermined direction.

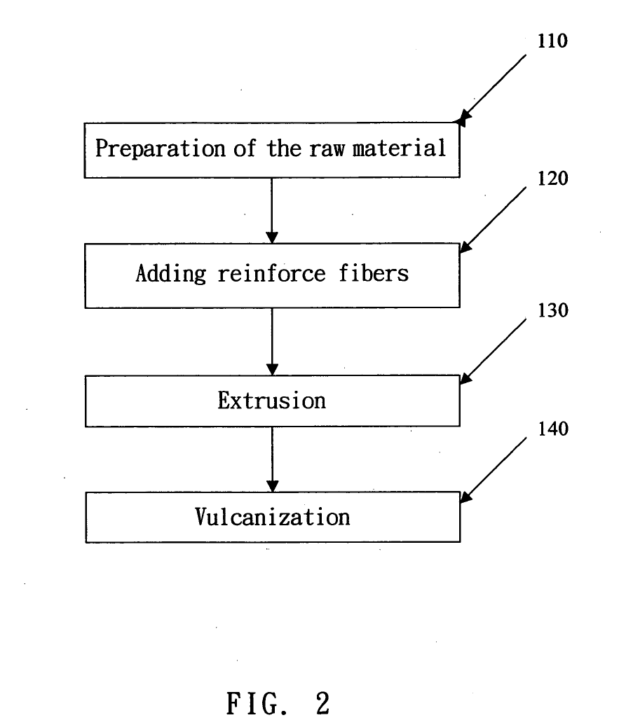

FIG. 2 shows the flow chart of a method of making the Yoga pad 10, including the step of:

Preparing a raw material 100: The raw material includes a flexible material, a foaming agent and a stabilizer in a predetermined ratio. The raw material 100 is put in a stirring machine for pressing and stirring, and then it is set to a mixing machine for modification. The raw material 100 includes a natural flexible material and an artificial flexible material, such as styrene-butadiene rubber (SBR), butadiene rubber (BR), and ethylene-propylene-non-conjugated diene rubber, such as EPDM), in a ratio of 4:1, a vulcanizing agent (sulfur), organic or inorganic foaming agent, such as azodicarbonamid (ADCA), accelerator, such as rubber vulcanization accelerator, TMTD, MBT) and filler for cost-down and change of physical property of the plastic, such as rubber grade carbon black, fumed silica, CaSiCO₃ and CaCO₃. The flexible material may be nature rubber (NB), polyurethane (PU), polyvinyl chloride (PVC), polyethylene (PE), and styrene-butadiene rubber (SBR). In the present invention we choose nature rubber.

Adding of reinforce fibers 110: Mixing reinforce fibers 14 in the raw material 100 to have a mixture.

Extrusion of foaming material 123: Put the mixture in a conventional extruder to get a plate member. The reinforce fibers 14 will be substantially oriented along an axial direction of the extruder in extrusion process.

Foaming 130: The plate member is put in a conventional vulcanization box for foaming. Chemical reaction will take between the natural rubber and the foaming agent to generate gas. After cooling, the foaming process is done to get the Yuga pad 10 with the reinforced fibers 14 therein.

The chemical reaction occurred in the foaming process will generate gas that makes the reinforce fibers 14 bonded in the foaming member 12. The extruder orients the reinforced fiber substantially along the same direction (the axial direction of the extruder). As a result, the Yuga pad 10 of the present invention has the reinforced fibers 14 therein and substantially orientated along the same direction. The Yuga pad 10 is not flexible along the reinforced fibers' 14 direction and is a little flexible along the orthogonal direction so that user may not slip because of the deformation of the Yuga pad. Furthermore, the Yuga pad 10 of the present invention has no adhesive.

In conclusion, the Yuga pad 10 of the present invention has the reinforced fibers 14 therein and substantially orientated along the same direction to replace the fabrics. The reinforced fibers decrease the flexibility of the pad to prevent user from slipping. The Yuga pad of the present invention has no adhesive to prevent pollution.

The description above is a few preferred embodiments of the present invention and the equivalence of the present invention is still in the scope of the claim of the present invention.

What is claimed is:

1. A Yuga pad, comprising a flexible foaming member and a plurality of reinforced fibers in the flexible foaming member, wherein the reinforced fibers are substantially oriented along a predetermined direction.

2. The golf club head as defined in claim 1, wherein the reinforced fibers are non-flexible.

3. The Yuga pad as defined in claim 2, wherein the reinforced fibers are wood fibers.

4. The Yuga pad as defined in claim 2, wherein the reinforced fibers are nylon fibers.

5. A method of making a Yuga pad, comprising the steps of:
preparing a raw material by mixing, pressing and stirring a flexible material, a foaming agent and an accelerator with a predetermined ratio;
adding reinforced fibers in the raw material to form a mixture;
sending the mixture into an extruder for extrusion to have a plate, wherein the extruder forces the reinforced fibers substantially along an axial direction of the extruder; and
vulcanizing the plate to have a flexible foaming member with the reinforced fibers therein, wherein the reinforced fibers are oriented substantially along a predetermined direction.

6. The method as defined in claim 5, wherein the raw material is sent to a stirring machine for pressing and stirring, and then sent to a mixing machine for modification and well mix.

7. The method as defined in claim 5, wherein the foaming agent is an organic foaming agent or an inorganic foaming agent.

8. The method as defined in claim 5, wherein the reinforce fibers are non-flexible.

9. The method as defined in claim 8, wherein the reinforce fibers are wood fibers.

10. The method as defined in claim 8, wherein the reinforce fibers are nylon fibers.

11. The method as defined in claim 5, wherein the flexible material is selected from the group consisting of nature rubber (NB), polyurethane (PU), polyvinyl chloride (PVC), polyethylene (PE), and styrene-butadiene rubber (SBR).
